(19) United States
(12) Patent Application Publication
(10) Pub. No.: US 2014/0124340 A1
(43) Pub. Date: May 8, 2014

(54) ELECTRICALLY-CONDUCTIVE MEMBRANE SWITCH

(71) Applicants: Joseph F. Pinkerton, Austin, TX (US); David A. Badger, Lago Vista, TX (US); William Neil Everett, Cedar Park, TX (US); William Martin Lackowski, Austin, TX (US)

(72) Inventors: Joseph F. Pinkerton, Austin, TX (US); David A. Badger, Lago Vista, TX (US); William Neil Everett, Cedar Park, TX (US); William Martin Lackowski, Austin, TX (US)

(21) Appl. No.: 14/123,628

(22) PCT Filed: Mar. 27, 2012
(86) PCT No.: PCT/US2012/030710

§ 371 Date: Dec. 3, 2013

Related U.S. Application Data
(60) Provisional application No. 61/493,241, filed on Jun. 3, 2011.

(51) Int. Cl. H01H 1/00

(52) U.S. Cl. CPC H01H 1/0094
USPC 200/181

(57) ABSTRACT

An improved electrically conductive membrane switch, such as, for example, an improved graphene membrane switch. The improved electrically conductive membrane switch can be used in applications requiring in excess of 100 volts.

### CROSS-REFERENCE TO RELATED PATENT APPLICATIONS

This application claims priority to: provisional U.S. Patent Application Ser. No. 61/493,241 filed on Jun. 3, 2011, entitled “Electrically-Conductive Membrane Switch” which provisional patent application is each commonly assigned to the Assignee of the present invention and is hereby incorporated herein by reference in its entirety for all purposes.

### TECHNICAL FIELD

The present invention relates to an electrically conductive membrane switch, particularly for use in applications requiring in excess of 100 volts. The electrically conductive membrane switch can be, for example, a graphene membrane switch.

### BACKGROUND

The present invention relates to an improved electrically conductive membrane switch, such as, for example, an improved graphene membrane switch. The improved electrically conductive membrane switch can be used in application requiring in excess of 100 volts (i.e., “high-voltage” applications).

Graphene membranes (also otherwise referred to as “graphene drums”) have been manufactured using a process such as disclosed in Lee et al. Science, 2008, 321, 385-388. PCT Patent Appl. No. PCT/US09/59266 (Pinkerton) (the “PCT US09/59266 Application”) described tunneling current switch assemblies having graphene drums (with graphene drums generally having a diameter between about 500 nm and about 1500 nm). U.S. Patent Appl. Nos. 61/391,727 (Pinkerton et al.) and 61/427,011 (Everett et al.) further describe switch assemblies having graphene drums. A switch that includes a graphene membrane is a graphene membrane switch.

FIG. 1 is a side view of a pre-existing graphene membrane switch 100 illustrated in the PCT US09/59266 Application (described in paragraphs [00114]-[00124 and in FIGS. 22-26), FIG. 2 is another illustration of the side view of the pre-existing graphene membrane switch illustrated in FIG. 1.

As illustrated in FIG. 1 (which is similar to FIG. 23 of the PCT US09/59266 Application), graphene membrane switch 100 uses a small (generally having a diameter between about 500 nm and about 1500 nm) graphene drum 102 that has a middle portion that periodically flexes down toward a metallic via 104 to vary its tunneling current gap. Generally, graphene membrane switch 100 requires an active feedback loop to maintain/control the gap between its moveable drum source 108 and via drain 110. Graphene membrane switch 100 can also use nanofilaments 124 in combination of the graphene drum 102 to vary the size of the tunneling gap 120.

As shown in FIG. 1, a DC voltage is between the source 108 and drain 110. A gate 112 is also positioned between the source 108 and drain 110, with oxide 114 sandwiched there between. Optionally, a metallic trace 122 can further be included for stacking and for connection with other electrically conductive membrane switches.

To turn the switch on, a voltage can be applied to gate 112 that is opposite polarity of the source/drum voltage. Once the graphene drum 102 gets within a few nanometers of the metallic via/drain 104, attractive van der Waals forces will also start to pull graphene drum 102 toward via 104. These attractive forces must be balanced with the mechanical restoration force of the graphene drum and force from compressing a gas (if a gas is present) within the chamber 118.

Unless the graphene drum 102 physically comes in contact with via 104, generally a stable equilibrium between these forces can be obtained by constantly adjusting the gate voltage to maintain a desired tunneling current gap 120 between graphene drum 102 and via 104. Because tunneling current varies dramatically with gap size (e.g., a one angstrom change in gap size can cause ten-fold change in tunneling current), it can be used as feedback to accurately control gap size. A voltage proportional to the tunneling current can be fed to a processor which in turn adjusts the gate voltage.

If a gas is present in chamber 118, the repulsive pressure force will increase due to the heat from the tunneling current. This increase in repulsive force can help to fine tune tunneling gap if many drum switches are placed in parallel with a parallel gate.

It is possible to adjust the relative dimensions of the drum switch so that the non-gate forces cancel when the drum is about 1 nanometer from the via 104 so that very small changes in gate voltage result in very large changes in tunneling current.

A graphene membrane as the electrically conductive membrane, other types of electrically conductive membranes (also referred to as “electrically conductive drums”) may be utilized in lieu of graphene membranes, such as, for example, graphene oxide membranes. A switch that includes a graphene oxide membrane is a graphene oxide membrane switch. A switch that includes a graphene/graphene oxide membrane is a graphene/graphene oxide membrane switch.

It has been found that the pre-existing electrically conductive membrane switches, such as illustrated in FIG. 1 and described in the above-mentioned applications, have limitations because they cannot “hold off” much voltage between their respective source/drain/gate layers. These limitations arise due to electrical breakdown of the oxide between the three metal layers (which generally occurs around 0.5 volts per nano-meter of oxide). These limitations also arise because the graphene membrane (or other electrically conductive membrane) is pulled with electrostatic forces toward the drain terminal; the closer the graphene gets to the drain terminal the stronger this force gets (because this force is proportional to the inverse square of the distance between graphene and drain). The only force counteracting the electrostatic force between source and drain is the mechanical restoration force of the graphene membrane.

It has also been found that pre-existing electrically conductive membrane switches have limitations due to the relatively high capacitance between their respective source, drain and gate traces (because these all overlap like a parallel-plate capacitor). The capacitance of such pre-existing electrically conductive membrane switches increases the turn on and turn off fillies of the switches, which limits each of the switches switching bandwidth.

It has also been found that the pre-existing electrically conductive membrane switches have a tendency for the graphene (or other electrically conductive membrane) to stick to the drain member (due to van der Waals forces) even when the gate is turned off.

It has also been found that, for pre-existing electrically conductive membrane switches, the drain via as drawn is very expensive to manufacture due to its high aspect ratio (the ratio of its length—including CNTs as shown—to diameter is greater than three times).

It has also been found that the pre-existing electrically conductive membrane switches have a current density that generally is higher at the center of the graphene membrane than at the outer diameter of the membrane, effectively creating a current choke point.

Accordingly, there is a need for an improved electrically conductive membrane switch to overcome these limitations, particularly when the electrically conductive membrane switch is to be used for applications requiring in excess of 100 volts.

### SUMMARY OF THE INVENTION

The present invention relates to an improved electrically conductive membrane switch, such as, for example, an improved graphene membrane switch. The improved electrically conductive membrane switch can be used in applications requiring in excess of 100 volts.

In general, in one aspect, the invention features an electrically conductive membrane switch that includes an electrically conductive membrane, an active source metal layer, and an active gate metal layer. The active source metal layer and the active gate metal layer do not overlap.

In general, in another aspect, the invention features an electrically conductive membrane switch that includes an electrically conductive membrane, an active drain conductive layer, and an active gate conductive layer. The active drain conductive layer and the active gate conductive layer are separated by a straight line distance. (The “straight line distance” between any two active conductive layers is the shortest path between these two active conductive layers). The active gate conductive layer is supported on an electrical insulator that has a thickness. The thickness of the electrical insulator is greater than the straight line distance.

Implementations of the inventions can include one or more of the following features:

The thickness of the electrical insulator can be greater than five times the straight line distance.

In general, in another aspect, the invention features an electrically conductive membrane switch that includes an active source layer, an active drain layer, and an electrically conductive membrane. There is an insulator path length between the active source layer and the active drain layer. The electrically conductive membrane has a maximum deflection distance. The insulator path length is greater than the maximum deflection distance.

Implementations of the above inventions can include one or more of the following features:

The insulator path length can be greater than five times the maximum deflection distance.

The electrically conductive membrane can be a graphene membrane.

In general, in another aspect, the invention features an electrically conductive membrane switch that is operable for use in applications requiring in excess of 100 volts.

### DESCRIPTION OF DRAWINGS

FIG. 1 illustrates a side view of a pre-existing graphene membrane switch.

FIG. 2 is another illustration of the side view of the pre-existing graphene membrane switch illustrated in FIG. 1.

FIG. 3 illustrates an array of graphene membrane switches of the present invention.

FIG. 4 illustrates one of the graphene membrane switches of FIG. 3.

FIG. 5A depicts a cross-sectional (a-a′) illustration of the graphene membrane switch illustrated in FIG. 4.

FIG. 5B depicts a different cross-sectional (b-b′) illustration of the graphene membrane switch illustrated in FIG. 4.

FIGS. 6A-6B illustrate the cross-sectional (a-a′) illustration shown in FIG. 5A with the graphene in its off and on states, respectively.

FIGS. 6C-6D illustrate the cross-sectional (b-b′) illustration shown FIG. 5B with the graphene in its off and on states, respectively.

FIGS. 7A-7D illustrate the same cross-sectional (a-a′ and b-b′) illustrations of FIGS. 6A-6D, respectively, in which the graphene has been coated with a metal.

FIG. 8 illustrates an alternate design of graphene membrane switch of the present invention that utilizes an apposing top-gate architecture.

FIG. 9 illustrates a differently shaped graphene membrane switch of the present invention.

FIG. 10A illustrates another array of graphene membrane switches of the present invention. FIG. 10B illustrates a magnification of the interface between two of the graphene membrane switches that depicts an optional current choke point feature that can be used in embodiments of the present invention.

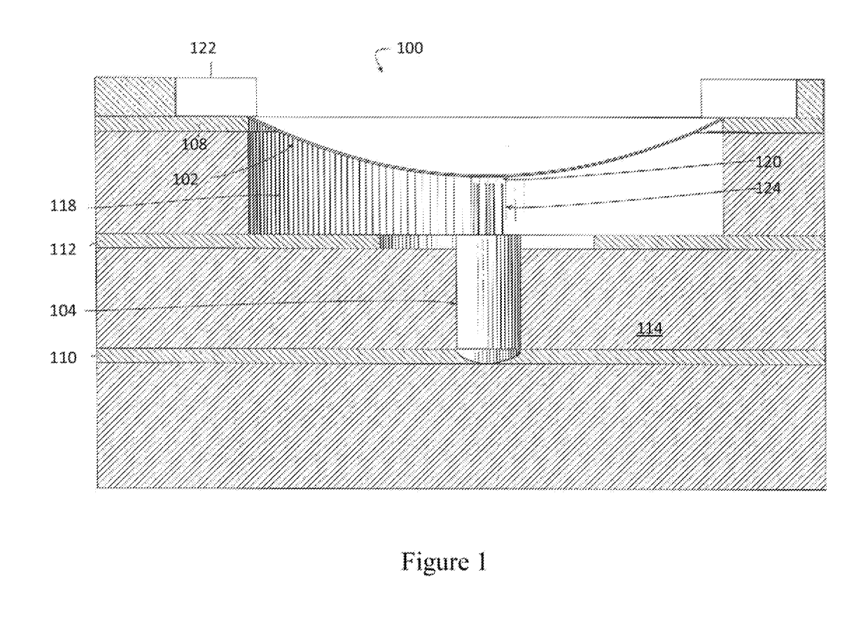

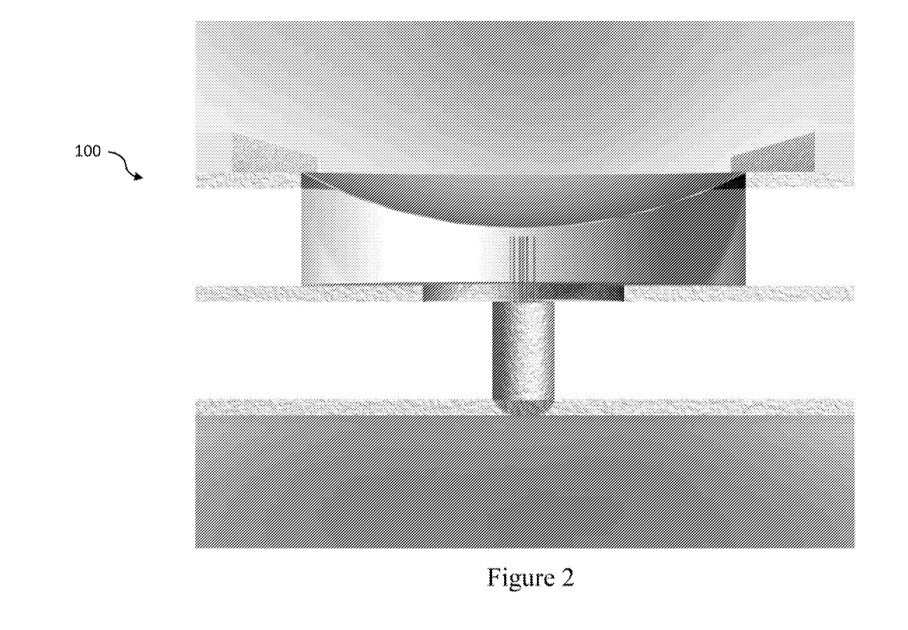

### DETAILED DESCRIPTION

The present invention relates to an improved electrically conductive membrane switch, such as, for example, an improved graphene membrane switch. The improved electrically conductive membrane switch can be used in applications requiring in excess of 100 volts. In the following discussion of the present invention, the electrically conductive membrane of the electrically conductive membrane switch will be a graphene membrane. However, a person of skill in the art of the present invention will understand that other electrically conductive membranes can be used in place of, or in addition to, graphene membranes (such as in graphene oxide membrane switches and graphene/graphene oxide membrane switches).

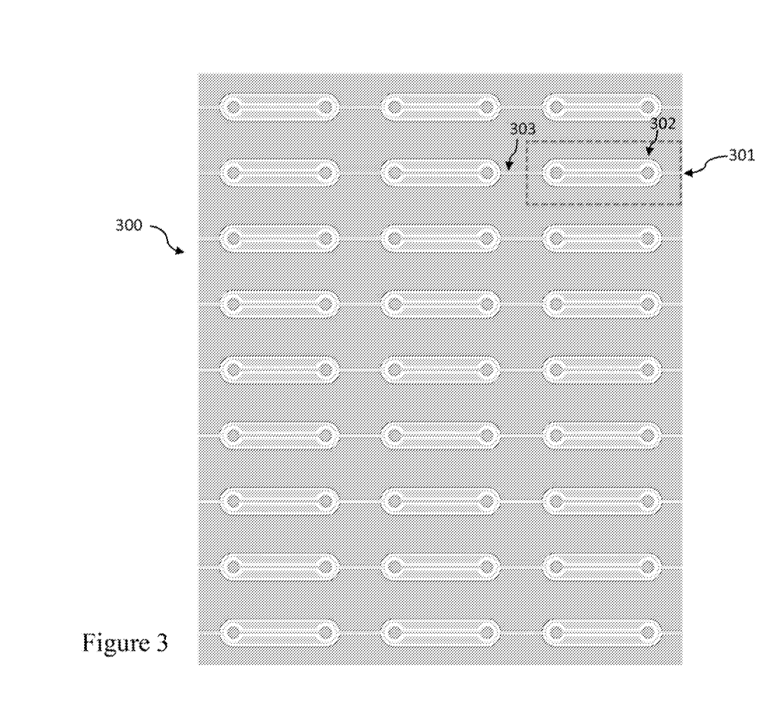

FIG. 3 shows an array 300 of switches 302 according to the present invention. The metal gates of switches 302 can be connected to one another using metal trace 303.

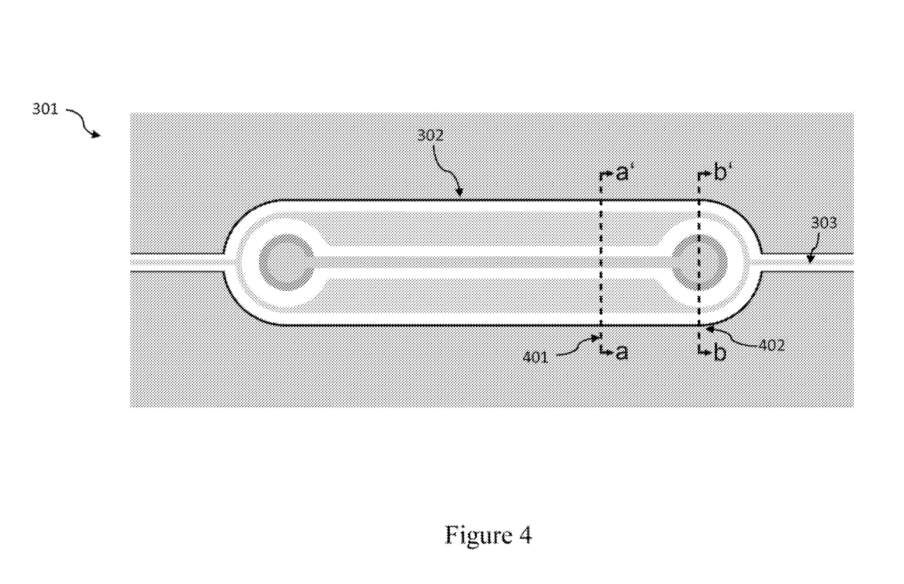

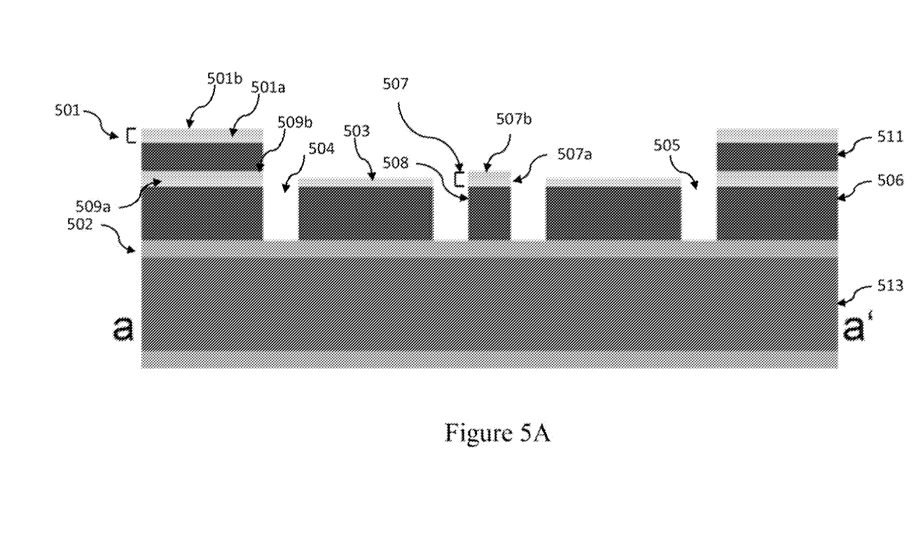

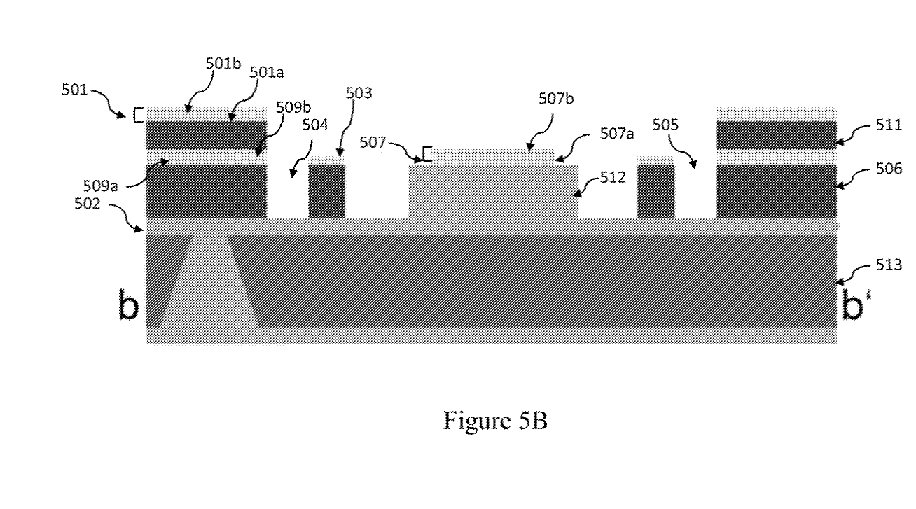

FIG. 4 is a close-up of the single graphene switch 302 shown in box 301 of FIG. 3. Two cross-sectionals of graphene switch 302 are identified in FIG. 4, namely cross-sectional 401 (a to a′) and cross-sectional 402 (b to b′). FIGS. 5A, 6A-6B and 7A-7B are illustrations of graphene switch 302 from the perspective of cross-sectional 401 FIGS. 5B, 6C-6D, and 7C-7D are illustrations of graphene switch 302 from the perspective of cross-sectional 402.

FIGS. 5A-5B depict the cross-sectional illustration of graphene membrane switch 302 illustrated in FIG. 4, at cross-sectionals 401 and 402, respectively. As shown in FIGS. 5A-5B, the source 501, drain 507, and gate 503 metal layers of graphene switch 302 do not overlap.

This means there is not a short oxide path between the metal layers (that can lead to a low hold-off voltage) and also the capacitance between the metal layers is relatively low. The vent lines 504 and 505 between each graphene membrane switch are also apparent. It has been found that the hold-off voltage of the graphene membrane switches of the present invention were effectively increased when vents were added to allow air to escape from the drum chamber (after the graphene was transferred to the metal-oxide chip in air) so that the graphene membrane switch could operate in a partial vacuum environment (the breakdown voltage of air being much lower than a moderate vacuum). It was unexpected how much better vacuum could hold of high voltage for graphene membrane switches as opposed to the oxide used in pre-existing graphene membrane switches. Indeed for pre-existing graphene membrane switches relatively thick oxides were needed, which did not perform as well as thinner oxide layers used in CMOS devices.

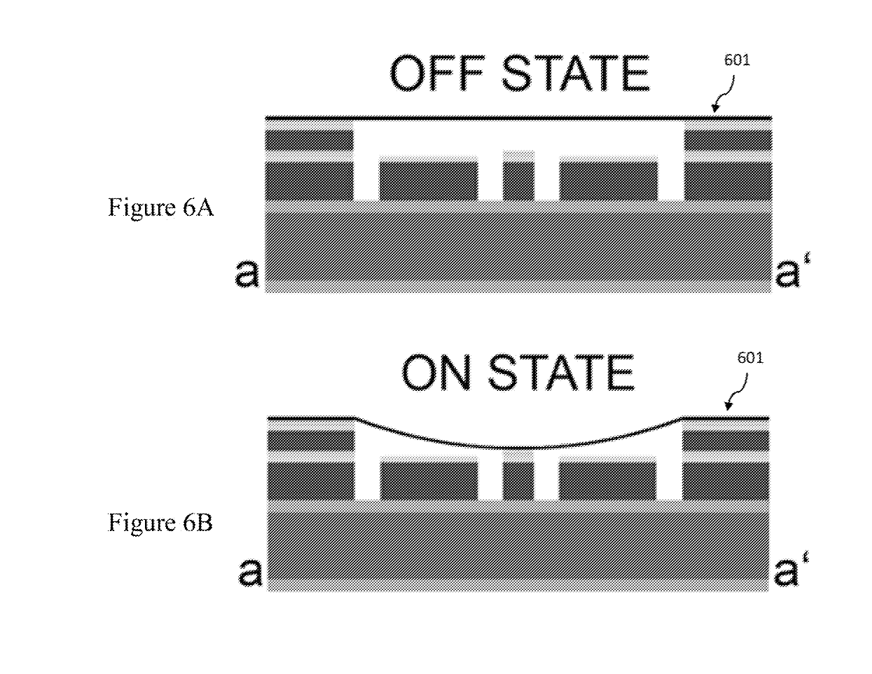

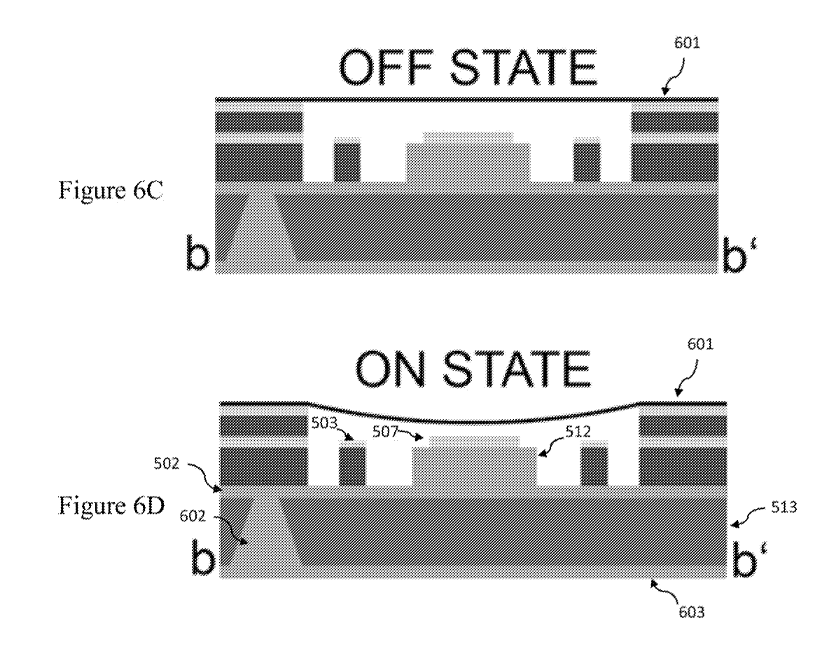

As further shown in FIGS. 5A-5B, the wide drain post 512 enables a thick layer of oxide 506 between the gate 503 and drain 507 metals (which increases hold-off voltage between gate 503 and drain 507). The drain trace 507 is also on a tall pillar of oxide 508, which separates drain trace 507 from both the source 501 and gate 503 metal layers. It should be noted that the gate 503 and drain 507 metal layers outside of the cavity are not connected to any voltages so there is not a voltage breakdown path between the oxide 506, 508, and 511 separating these layers and the source/top 501 metal layer. FIGS. 5A-5B further shows that the drain trace 507 has a metal 507b on top of the metal 507a so that the drain trace 507 is closer to the center part of the graphene than the gate 503 metal. (Such as the graphene membrane 601 shown in FIGS. 6B and 6D). The metal 507a in FIGS. 5A-5B (as well as the metals 501a and 509a) can be a good electrical conductor like Al, and the metal 507b (as well as metals 501b and 509b) should be a good electrical conductor that does not form an oxide layer (which would increase graphene membrane switch on state losses) like Au or Pt. Metal 509a is an inactive metal layer (no voltage is applied to and no current is routed through this layer) and gate 503 is an active metal layer (voltage is applied to or current is routed through this layer).

Embodiments of the present invention can be made using conventional metals such as Al and the sputter on a thin (a few nanometers thick) film of non-oxidizing metal such as Pt or Au after the wafer leaves the semiconductor plant. This is advantageous because most facilities will not allow Pt or Au in their plants. Furthermore, the oxide walls are so tall between metal traces that the deposited metal will not be able to form a continuous electrical path between the metal traces. Additionally, a Pt or Au wet etch can be used to remove any metal on the side walls of the oxide without completely removing it from the top of the metal traces because the metal on the walls will generally be much thinner than on top of the traces.

Also, the drain post 512 is wider than the center drain bar 507. This design allows the graphene 601 to touch down along the center portion (the middle ˜30%) of the drain trace 507, minimizing current choke points in the graphene 601 and also allowing the drain post 512 to be wider (and thus deeper, which allows thicker oxide—and thus higher standoff voltage—between gate 503, source 501, and drain 507 metal layers) without increasing the electrostatic attraction between the graphene 601 and the center portion of drain trace 507.

FIGS. 6A-6D shows the graphene membrane switch 301 with graphene 601 in its “off” and “on” states. FIGS. 6A and GC depict the cross-sectional illustration of graphene membrane switch 302 illustrated in FIG. 4 at cross-sectionals 401 and 402, respectively, with the graphene 601 in its “off” position. FIGS. 6B and 6D depict the cross-sectional illustration of graphene membrane switch 302 illustrated in FIG. 4 at cross-sectionals 401 and 402, respectively, with the graphene 601 in its “on” position.

As discussed above, the center portion of graphene 601 deflects toward the center portion of the drain trace 507. The graphene 601 contacts the center of the drain trace 507 but not the drain post 512 (since the center portion of the graphene 601 deflects with a lower force than the portions near the edge of device).

FIGS. 6A-6D also show how the current can enter the top of the switch and exit at the bottom of the switch. Referring to FIG. 6D, the current enters at the graphene 601, flows into drain trace 507 then flows down through drain post 512, then into drain plane 502 metal on top of the Si 513, and then through large metal drain via 602 to drain electrode 603 on the bottom of Si 513 (or other support wafer). In the off state, the drain trace 507 and graphene 601 (and gate 503 and graphene 601) are separated by vacuum (which can hold off around 5 V per urn or around ten times more voltage/nm than a typical dielectric greater than 100 nm thick). The gate and drain traces can be separated by vacuum or by tail oxide structures. In some embodiments of the present invention, the optimal oxide path between the gate/drain/source metals should be at least around ten times the distance of the vacuum path between these structures to maximize hold-off voltage.

During manufacture, it can be advantageous to precondition the graphene membrane switches before shipment by turning them on and running a substantial current through the membrane for a few minutes, it has been found that such a procedure has lowered on resistance of a graphene membrane switch by more than a factor of 10.

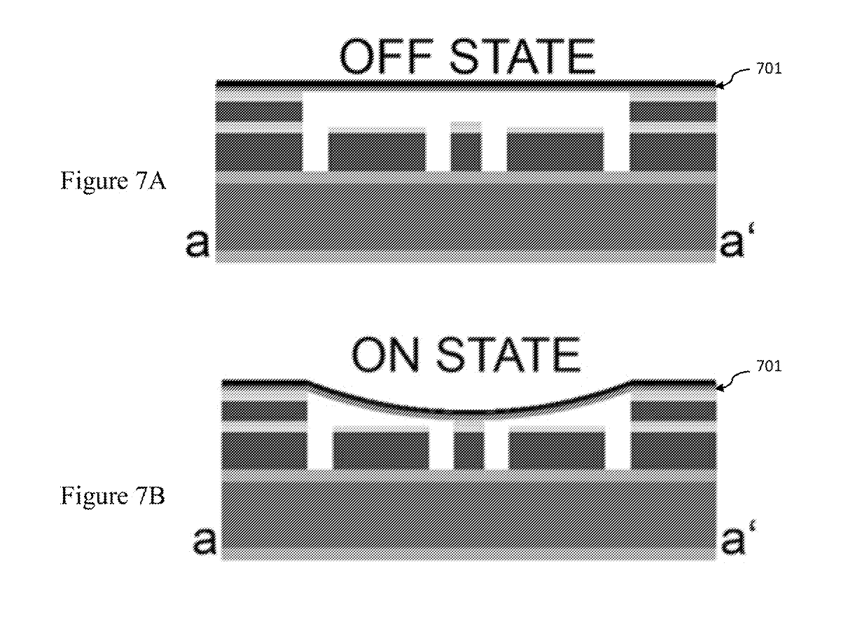

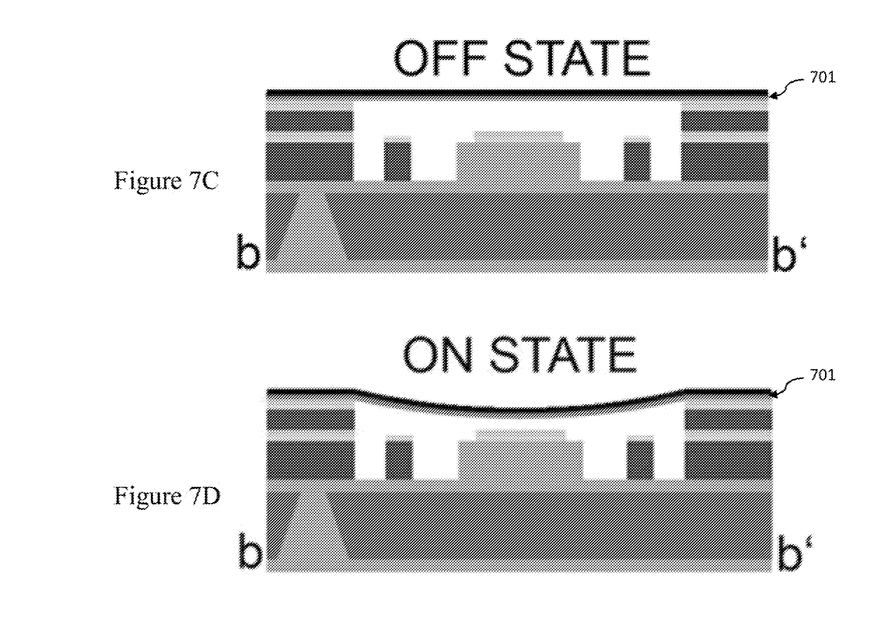

FIGS. 7A-7D illustrate the same cross-sectional illustrations of FIGS. 6A-6D. respectively, in which the graphene has been coated with a metal 701, which can lower the “on” resistance of the switch. Alternatively 701 can be one or more graphene layers, which can be used to hold off a higher voltage between source and drain. Additional layers of graphene can also increase current carrying capacity.

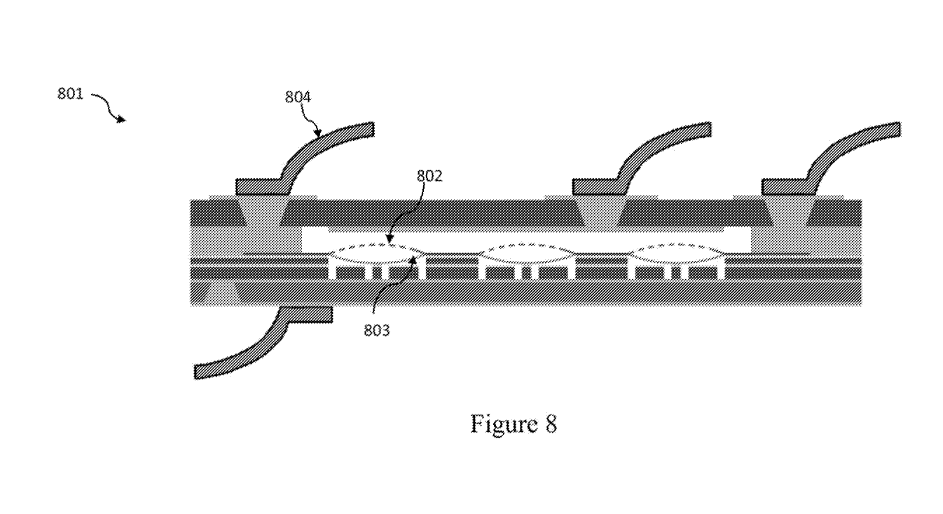

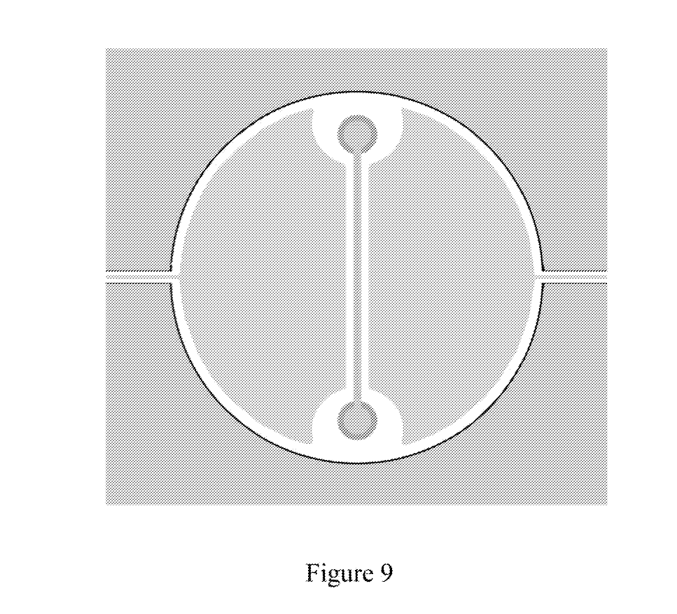

FIG. 8 shows a graphene membrane switch array 801 with an upper gate in addition to a lower gate and also shows how current can be routed in/out of the graphene membrane switch array. The upper gate can be used to increase source-drain hold-off voltage without increasing lower gate voltage: when the switch array is off, the upper gate pulls the graphene away from the drain trace (as shown as dotted line 802). This increases hold-off voltage in two ways: first, the larger distance between the graphene and drain lowers the electrostatic three, second, the upper gate force (which may be higher than the restoration force of the graphene alone) counteracts the drain force. The upper gate may be connected to the drain voltage so that the graphene is automatically pulled away from the drain (since it has much higher surface area facing the graphene than the drain) when a voltage is applied between source and drain. The line 803 shows the graphene in the “On” position, when the bottom gate turns the switch on.

It is advantageous to coordinate the upper and lower gates. For example, it makes sense to decrease the upper gate voltage as the lower gate voltage increases to turn the graphene membrane switch on. The upper gate can also be used to pull the graphene of the drain trace when it is stuck with van der Waals forces. FIG. 8 also shows how current can be routed from the top of the graphene membrane switch chip to the bottom of the graphene membrane switch chip using bond wires 804, metal vias, etc.

FIG. 9 shows how the graphene membrane switch can be differently shaped (such as round) than the trough-shaped graphene membrane switches illustrated in FIG. 4

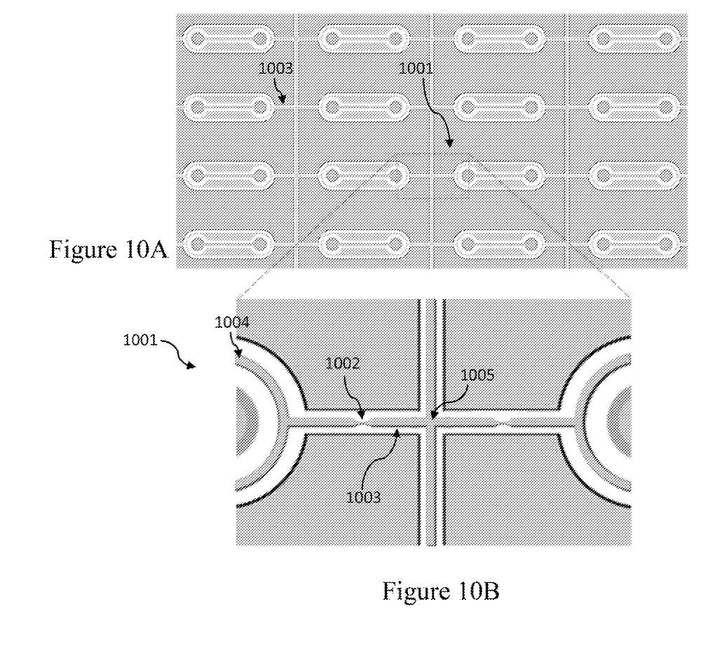

In some embodiments, an additional feature can be added to the high-voltage graphene membrane switch, illustrated in FIGS. 10A-10B. FIG. 10B illustrates a magnification of the interface between two of the graphene membrane switches (magnified box 1001 shown in FIGS. 10A-10B) that depicts an optional current choke point feature 1002 that can be used in embodiments of the present invention.

The metal traces 1003 connecting the metal gates 1004 of each graphene membrane switch are very thin, which is to reduce/minimize capacitance and which is also used to “fuse” the gate of each graphene membrane switch. If the graphene of a particular graphene membrane switch break's and falls down on the metallic gate, a current will flow between the source/top metal and the gate metal. This current will be high enough to burn out the trace (breaking this fuse-like structure of metal immediately to the left and right of the shorted switch cavity. Since the current splits into three paths near the “cross” 1005 to the left and right of the affected switch (thus reducing the current density in these traces by a factor of three), these metal traces should not be damaged during the process of breaking the fuse-like structure. FIG. 10B shows an optional current choke point feature 1002 (thinned down portion of the metal trace 1003) to create the fuse-like structure.

If the graphene breaks and falls onto the drain trace, the graphene itself will act as the fuse, because the source-drain voltage/current capacity are high enough to burn out the grapheme (whereas the weaker gate circuit is generally unlikely to have enough voltage/current capacity to blow out the graphene itself).

These two fuse-like mechanisms will allow a high-voltage graphene membrane switch assembly to quickly and automatically isolate damaged grapheme membrane switches from the good graphene membrane switches. A typical graphene membrane switch array will have on the order of 10 million individual graphene membrane switches, so losing even several thousand individual graphene membrane switches will not seriously compromise the operation of the graphene membrane switch assembly.

Implementations of the above inventions can include one or more of the following features:

The path through the oxide between active metal layers is at least three times longer than the path between the metal layers in air or vacuum.

The source metal does not overlap with the active gate metal.

The drain trace runs along the center of the switch cavity and is connected to at least one metal via.

The active drain trace does not overlap with the source or active gate metal.

The active drain trace metal is closer to the electrically conductive membrane than the active gate trace metal (for example two drain metals versus one gate metal). By placing the active dram trace closer to graphene than the active gate trace, the switch was found to be much more stable in this configuration.

An upper gate is used in addition to a lower gate.

The electrically conductive membrane is comprised of a composite membrane (graphene/metal, graphene/graphene, graphene/graphene oxide, etc.).

The membrane switch is pre-conditioned/annealed (“burned in”) in place by operating it with a high current before consumer usage.

The switch cavities are connected through a series of vents.

The membrane switch cavity is longer parallel to drain trace than perpendicular to drain trace.

An upper chip is mounted on a lower switch cavity chip and used to route current (and in some cases support the upper gate).

The height of the dielectric layer supporting the drain trace is at least 3× the width of the drain trace.

The drain post electrically connected to the drain trace has a diameter larger than the width of the drain trace.

Embodiments of the present invention provided some unexpected benefits as compared with the pre-existing graphene membrane (and other electrically conductive membrane) switches, particularly with regard to high-voltage applications.

It was unexpected how much better vacuum could hold off high voltage for graphene membrane switches as opposed to the dielectric used in pre-existing graphene membrane switches. Indeed for pre-existing graphene membrane switches, relatively thick dielectric layers are needed, which do not perform as well as thinner dielectric layers used in CMOS.

The benefit of annealing the graphene was also unexpected.

The high level of capacitive coupling between the source/gate/drain in pre-existing graphene membrane switches was also unexpected, as were the benefits of lowering this level of capacitive coupling.

It was also unexpected that one-atom-thick graphene would act as such a good barrier between air and vacuum, as were the benefits of haying vents to evacuate the air from within the switch cavity beneath the graphene membrane.

Furthermore, the overall strength of the van der Waals forces in a switch configuration was unexpected; thus there is a benefit in having more than one layer of graphene on the source metal layer to increase the “pull” force needed to turn the switch off.

The cost and difficulty of making metal vias or posts with a length to diameter ratio above three to four times was unexpected, which were overcome with the novel drain trace design disclosed herein.

It was also unexpected to see the center of the graphene membrane boil off coatings (polymers, metals, etc.) because of the current pinch points of the graphene membrane and the centered metal via design. It was also unexpected how well oxides can be etched for embodiments of the present invention, which allowed for the creation of a thin (around 200 nm) drain bar that is supported by a 200 nm wide oxide structure that is between one and a few microns tall.

Moreover, it was unexpected that a drain trace that runs perpendicular to the long dimension of a graphene membrane trough would create an undesirable saddle shape in the graphene membrane that makes the graphene membrane land on the sharp edges of the drain trace and could sometime result in the graphene membrane touching the gate (and thus creating an electrical short between the graphene membrane and the gate) before the graphene membrane can contact the drain. Running the drain trace along the long dimension of the trough in embodiments of the present invention results in the graphene membrane landing on the flat part of the drain trace and minimizing the saddle effect.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, other embodiments are within the scope of the following claims. The scope of protection is not limited by the description set out above, but is only limited by the claims which follow, that scope including all equivalents of the subject matter of the claims.

The disclosures of all patents, patent applications, and publications cited herein are hereby incorporated herein by reference in their entirety, to the extent that they provide exemplary, procedural, or other details supplementary to those set forth herein.

1. An electrically conductive membrane switch that comprises:
(a) an electrically conductive membrane;
(b) an active source metal layer; and
(c) an active gate metal layer, wherein the active source metal layer and the active gate metal layer do not overlap.

2. An electrically conductive membrane switch that comprises:
(a) an electrically conductive membrane;
(b) an active drain conductive layer; and
(c) an active gate conductive layer, wherein
(i) the active drain conductive layer and the active gate conductive layer are separated by a straight line distance,
(ii) the active gate conductive layer is supported on an electrical insulator that has a thickness, and
(iii) the thickness of the electrical insulator is greater than the straight line distance.

3. The electrically conductive membrane switch of claim 2, wherein the thickness of the electrical insulator is greater than five times the straight line distance.

4. An electrically conductive membrane switch that comprises:
(a) an active source layer;
(b) an active drain layer, wherein there is an insulator path length between the active source layer and the active drain layer; and
(c) an electrically conductive membrane, wherein
(i) the electrically conductive membrane has a maximum deflection distance, and
(ii) the insulator path length is greater than the maximum deflection distance.

5. The electrically conductive membrane switch of claim 4, wherein the insulator path length is greater than five times the maximum deflection distance.

6. The electrically conductive membrane switch of claim 4, wherein said electrically conductive membrane is a graphene membrane.

7. An electrically conductive membrane switch that is operable for use in applications requiring in excess of 100 volts.

8. The electrically conductive membrane switch of claim 7, wherein the electrically conductive membrane switch comprises a membrane selected from the group consisting of a graphene membrane, a graphene oxide membrane, and a graphene/graphene oxide membrane.

9. The electrically conductive membrane switch of claim 7, wherein the electrically conductive membrane switch has vents operable for allowing air to escape from the electrically conductive membrane switch so that the switch operates in a partial vacuum environment.

10. The electrically conductive membrane switch of claim 1, wherein said electrically conductive membrane is a graphene membrane.

11. The electrically conductive membrane switch of claim 2, wherein said electrically conductive membrane is a graphene membrane.

12. The electrically conductive membrane switch of claim 2, wherein the active drain conductive layer is closer to the electrically conductive membrane than the active gate conductive layer.

13. The electrically conductive membrane switch of claim 12, wherein said electrically conductive membrane is a graphene membrane.

14. The electrically conductive membrane switch of claim 2 further comprising a second active gate conductive layer, wherein
(a) the electrically conductive membrane has a first side and a second side;
(b) the active gate conductive layer is located on the first side of the electrically conductive membrane; and
(c) the second active gate conductive layer is located on the second side of the electrically conductive membrane.

15. The electrically conductive membrane switch of claim 14, wherein the second active gate conductive layer is operable to increase source-drain hold-off voltage without increasing voltage at the active gate conductive layer.

16. The electrically conductive membrane switch of claim 14, wherein the second active gate conductive layer is operable to pull the electrically conductive membrane away from the active drain layer.

17. The electrically conductive membrane switch of claim 14, wherein
(a) a first voltage source is connected to the active gate conductive layer;
(b) a second voltage source is connected to the second active gate conductive layer; and
(c) the electrically conductive membrane switch is configured to turn on by increasing the first voltage and decreasing the second voltage.

18. The electrically conductive membrane switch of claim 17, wherein the electrically conductive membrane switch is configured to turn off by decreasing the first voltage and increasing the second voltage.

19. The electrically conductive membrane switch of claim 18, wherein said electrically conductive membrane is a graphene membrane.

20. The electrically conductive membrane switch of claim 4, wherein the electrically conductive membrane switch comprises a membrane selected from the group consisting of a graphene oxide membrane and a graphene/graphene oxide membrane.
